(19) United States
(12) Patent Application Publication
(10) Pub. No.: US 2010/0114777 A1
(43) Pub. Date: May 6, 2010

(54) Administration of Dual Component Financial Instruments

(75) Inventors: Michael T. Rusk, Laurel, MD (US); Catherine B. Reynolds, McLean, VA (US); Paula K. Darling, Great Falls, VA (US); Matthew W. Murray, Vienna, VA (US)

Correspondence Address: BANNER & WITCOFF, LTD., 1100 13th STREET, N.W., SUITE 1200, WASHINGTON, DC, 20005-4051, US

(73) Assignee: EDUCAP, INC., McLean, VA (US)

(21) Appl. No.: 12/650,665

(22) Filed: Dec. 31, 2009

Related U.S. Application Data
(63) Continuation of application No. 11/066,445, filed on Feb. 28, 2005.

(51) Int. Cl. G06Q 40/00

(52) U.S. Cl. 705/44; 705/39

(57) ABSTRACT

Methods and systems for administering a dual component financial instrument (DCFI) are described. The DCFI includes a revolving loan component and one or more installment loans. A holder of the DCFI account can use the revolving loan to pay for expenses, e.g., educational expenses. At predetermined intervals, e.g., annually on the anniversary date of the DCFI account, a new installment loan is automatically created on behalf of the account holder to pay off the revolving loan. Automatically creating an installment loan to pay off the revolving loan frees up the revolving loan for use by the borrower to pay for expenses during the next interval, e.g., the next school year, and allows the lender to quickly and efficiently securitize portions of the funds provided to the borrower.

### CROSS REFERENCE TO RELATED APPLICATIONS

This application is a continuation application of Ser. No. 11/066,445, filed Feb. 28, 2005, and having the same title.

### FIELD OF THE INVENTION

The invention relates generally to financial systems. More specifically, the invention provides a dual-component financial instrument primarily for educational lending purposes, and an associated computer system for administering the dual-component financial instrument to and on behalf of others.

### BACKGROUND OF THE INVENTION

In the 1980s, vast numbers of potentially college-bound students were not eligible for federal student loan programs because their family incomes were too high. Paradoxically, those same families sorely lacked adequate financial resources to pay for college on their own. What was needed was a private initiative to cure a public policy problem. EduCap Inc., a not-for-profit education organization, quickly discerned this demand for education financing that went beyond the narrow, need-based confines of existing federal programs. Forging a nationwide network of strategic alliances, EduCap pioneered the concept of privately-funded, credit-based education lending—the first true, practical alternative to government student loan programs.

The success of this simple yet powerful idea inspired EduCap to create a family of unique, unsecured education loan programs. In so doing, EduCap—which has disbursed billions of dollars in student loans since its founding—laid the foundation for today's multibillion-dollar private student loan industry. EduCap's innovative and entrepreneurial approach took a traditionally ponderous, process-driven industry by storm, and revolutionized student lending. As a consequence, millions of students—students who might otherwise have never been able to pay for a higher education—were able to earn college degrees. These students are out there every day, hard at work building better lives for themselves, for their families, and for society at large.

In creating and building the privately-funded, credit-based education lending industry in the United States, EduCap has created a multibillion-dollar industry; securitized credit-based education loans on Wall Street, uniformly attaining AAA ratings; marketed private student loan programs directly to consumers; developed customized credit scoring models and incorporated risk-based pricing into education financing products; and provided access to education financing as an employee benefit for corporations.

Part of EduCap's success is due to the securitization of credit-based educational loans to financial markets. The securitization of a loan is simplified if the loan is fully disbursed and in the repayment period. As a result, lenders typically provide educational loans on an annual or semester basis so that the lender can sell the current year's batch of loans at the end of the year to obtain the necessary capital that is to be used to provide the following year's batch of loans. If a lender keeps a loan open for more than one year then the available cash flow for new loans is thereby reduced.

While some lines of credit secured with equity in a borrower's real property have been offered, these home equity lines of credit typically have a lengthy draw period, e.g., ten years. However, such borrowing can erase years in the value of appreciation of one's home. In addition, if the borrowing comes close to retirement for the borrower it may reduce income in later years of the borrower's life. For families with several children in college, the equity might not be enough to cover college expenses for all children. Finally, borrower risks losing the real property used to obtain the home equity loan or line of credit in the first place, and the student cannot be a party to the loan (unless, of course, it is the student's home equity loan or line of credit).

Another problem in the prior art is that there is a cumbersome amount of paperwork and procedures that must be completed and performed for each loan that is to be securitized and sold on a financial market. Yet another problem in the prior art is that there is a lack of breadth in the presently available educational loan products offered to students. Thus, it would be an advancement in the art to provide a loan product and associated administrative system that eases the administration of educational loan products, and it would be a further advancement in the art to provide a new educational loan product that provides more flexibility to a borrowing student than previously available products.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, the present invention is directed to methods and systems for providing a dual component financial instrument by storing revolving loan information corresponding to a revolving loan provided to a borrower by a lender, and then, when a predetermined condition is met, automatically establishing on behalf of the borrower an installment loan for a predetermined amount, storing loan information corresponding to the loan, and automatically crediting the predetermined amount towards an outstanding balance of the revolving loan. In this manner, borrowers, e.g., a students, can obtain a loan product that provides access to funds for an entire post-secondary education through a single application process. Each year, e.g., at the anniversary date of the dual component financial instrument, an installment loan is automatically created to pay off the balance accrued by the student on the revolving loan to pay for educational expenses for the previous year.

Another illustrative aspect of the invention provides a data processing device for administering dual component financial instruments as described herein. The data processing device, under control of a processor executing computer executable instructions stored in a memory, performs an automated method for administering a financial instrument having a revolving loan component and one or more installment loan components. The data processing device stores revolving loan information corresponding to a revolving loan provided to a borrower by a lender, where the revolving loan information comprises a maximum annual balance and a maximum lifetime balance. The data processing device, on or near each anniversary date of an establishment date of the revolving loan, automatically rolls over the revolving loan by storing loan information for a discrete fixed-term installment loan automatically established on behalf of the borrower for an amount of money based on a current outstanding balance of the revolving loan, automatically crediting the amount of money towards the current outstanding balance of the revolving loan, and automatically adding the predetermined amount to a lifetime balance of the revolving loan. The outstanding balance of the revolving loan is not allowed to exceed the maximum annual balance, and the lifetime balance plus the current outstanding balance of the revolving loan is not allowed to exceed the maximum lifetime balance.

According to another illustrative aspect of the invention, a charge card may store in a memory account information corresponding to a financial instrument having a revolving loan component and a loan component. Use of the charge card draws from the revolving loan component of the financial instrument, and the revolving loan may be automatically paid off by a new automatically created fixed-term installment loan on or near each anniversary of an establishment date of the financial instrument.

In yet another illustrative aspect of the invention, a charge card transaction against a revolving loan of a financial instrument having a revolving loan component and one or more installment loan components may be processed to determine whether to authorize or deny the requested amount, where use of the charge card draws from the revolving loan component of the financial instrument, and the revolving loan is automatically paid off by a new automatically created fixed-term installment loan on or near each anniversary of an establishment date of the financial instrument. Processing the charge card request may include receiving a charge card authorization request, sent by a merchant, comprising a requested amount and an account identifier, wherein the account identifier corresponds to the dual component financial instrument. The processor of the request then determines whether the requested amount is within an annual credit limit of the revolving loan component, and whether the requested amount is within a lifetime limit of the revolving loan component. The processor of the request approves the charge card authorization request when the requested amount is within the annual credit limit of the revolving loan component and the requested amount is within the lifetime limit of the revolving loan component, and denies the charge card authorization request when the requested amount would exceed the annual credit limit of the revolving loan component or the requested amount would exceed the lifetime limit of the revolving loan component. The processor of the request then sends for delivery to the merchant a charge card authorization response indicating the result.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a timeline of a revolving loan and corresponding installment loans over the lifespan of a dual component financial instrument according to an illustrative embodiment of the invention.

FIG. 2 illustrates a network architecture that may be used according to an illustrative embodiment of the invention.

FIG. 3 illustrates a block diagram of a data processing device that may be used to perform one or more aspects of an illustrative embodiment of the invention.

FIGS. 4A and 4B illustrates a computer assisted method for establishing and administering financial transactions against a dual component financial instrument according to an illustrative embodiment of the invention.

FIGS. 5A, 5B, and 5C illustrate a computer assisted method for managing a dual component financial instrument according to an illustrative embodiment of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

By way of introduction and not limitation, aspects of the present invention provide a method and system for automating the administration and processing of a dual component financing instrument (DCFI), which includes a revolving loan component for use by a borrower on an annual basis (e.g., by a student during a school year), and an installment loan component into which the revolving loan is automatically converted on an annual or other predetermined basis. A revolving loan is also sometimes known to consumers as a line of credit, as is typically used, e.g., with respect to a credit card account.

The first component of the DCFI is a revolving loan usable by a borrower, e.g., a student. The second component of the DCFI includes one or more installment loans automatically created to pay off the revolving loan at regular or fixed intervals, such as annually or at the end of a school year, or when the outstanding balance of the revolving loan reaches a certain amount. The DCFI may have a lifespan during which the revolving loan is open, an annual maximum balance, and a lifetime maximum balance. The annual maximum balance is the maximum outstanding balance that the borrower can draw on the active revolving loan. The lifetime maximum balance is the maximum amount over the life span of the DCFI that the borrower can draw, and includes the outstanding balance of the revolving loan plus any installment loans automatically created to pay off the revolving loan. The revolving loan may have an associated interest rate, and each installment loan may also be established with criteria such as repayment term, interest rate, etc. Each borrower may have various repayment options, including deferment until graduation (interest is added to principal), payment of interest only until graduation, or immediate repayment of principal plus interest.

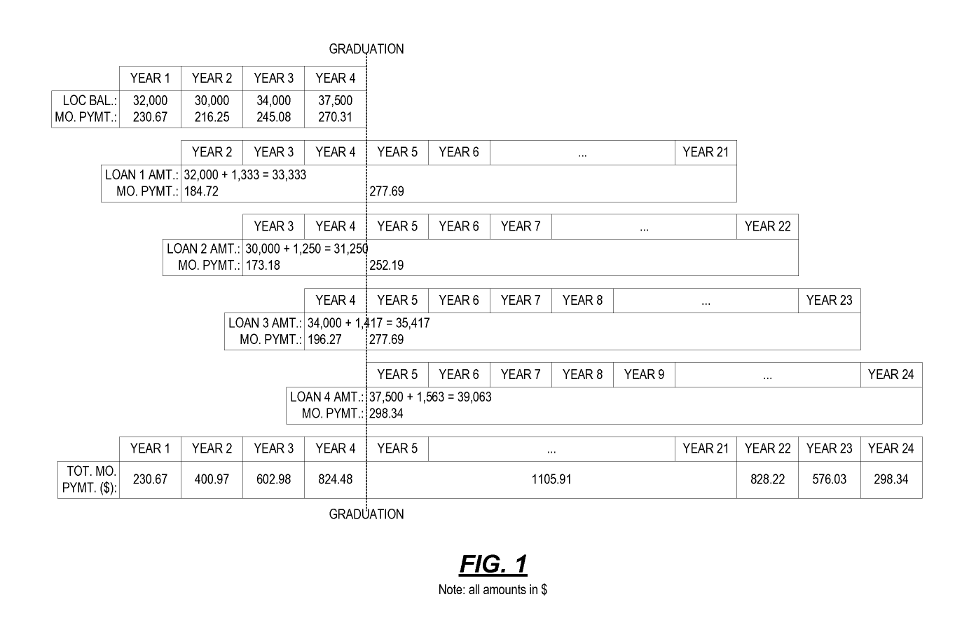

Using the dual-component financing instrument described herein, students can obtain a loan product that provides access to funds for an entire post-secondary education through a single application process. For example, with reference to FIG. 1, a DCFI may have a 4-year lifespan, an annual maximum balance of $37,500, and a lifetime maximum balance of $150,000. FIG. 1 illustrates a timeline where the repayment term for installment loans is 20 years each, the credit line interest rate is Prime +3.9%, and the interest rate of each installment loan is Prime +1.9%, with a 4% origination fee. A borrower (e.g., a student) under such a DCFI could draw up to $37,500 each year to pay for items such as tuition, housing, food and living expenses, airfare home, auto payments, utilities, etc. At the end of each year, e.g., at the end of each school year or on the anniversary date of the DCFI, an installment loan is automatically created to pay off the outstanding balance of the revolving loan. The amount of the installment loan (optionally including any origination fees) is added to the lifetime balance of the DCFI, and the revolving loan balance returns to $0. The full revolving loan is thus made available for the next school year.

FIG. 1 is illustrative only and the amounts in FIG. 1 assume that the entire revolving loan balance is drawn at the beginning of the revolving loan year. Obviously the borrower might not draw the entire balance at the beginning of the year, and instead only draw as much money as he or she needs at any given time, and thus monthly payments on the revolving loan may vary. In this example, during the first year the borrower draws $32,000 from the revolving loan, creating a monthly minimum payment of $230.67 for the revolving loan, which can be paid or deferred depending on the terms of the DCFI. In this example, the borrower makes monthly interest payments on the revolving loan. Thus, during year 1 (e.g., freshman year) the total monthly payments are $230.67.

At the end of the first year, the revolving loan balance is paid off through the creation of a first 20-year installment loan with a balance of $33,333 ($32,000+4% origination fee based on loan amount of $33,333). Prior to graduation, the first installment loan may have an interest only monthly payment of $184.72. The repayment terms of the first installment loan may specify that, beginning after graduation or after some grace period, the payments include principal and interest, totaling $277.69. During the second year, in this example the borrower draws $30,000 from the revolving loan, with interest only monthly payments of $216.25. Thus, the total monthly payments during year 2 (e.g., sophomore year) are $400.97.

At the end of the second year, the revolving loan balance is paid off through the creation of a second 20-year installment loan with a balance of $31,250 ($30,000+4% origination fee based on loan amount of $31,250). Prior to graduation, the second installment loan may have an interest only monthly payment of $173.18. The repayment terms of the second installment loan may specify that, beginning after graduation or after some grace period, the payments include principal and interest, totaling $252.19. During the third year, in this example the borrower draws $34,000 from the revolving loan, with interest only monthly payments of $245.08. Thus, the total monthly payments during year 3 (e.g., junior year) are $602.98.

At the end of the third year, the revolving loan balance is paid off through the creation of a third 20-year installment loan with a balance of $35,417 ($34,000+4% origination fee based on loan amount of $35,417). Prior to graduation, the third installment loan may have an interest only monthly payment of $196.27. The repayment terms of the third installment loan may specify that, beginning after graduation or after some grace period, the payments include principal and interest, totaling $277.69. During the fourth year, in this example the borrower draws the annual maximum $37,500 from the revolving loan, with interest only monthly payments of $270.31. Thus, the total monthly payments during year 4 (e.g., senior year) are $824.48.

At the end of the fourth year, the revolving loan balance is paid off through the creation of a fourth 20-year installment loan with a balance of $39,063 ($37,500+4% origination fee based on loan amount of $37,500). Because the end of the fourth year, in this example, coincides with graduation, the fourth installment loan's monthly payments might include interest only, $216.47, for some grace period after graduation, or might include principal and interest, $298.34, from the disbursement date. Assuming the fourth installment loan begins with payments including principal and interest, and each of the previous three installment loans also transition to principal and interest payments beginning at graduation, total monthly payments from year 5 through year 21 (the last year of the first installment loan) are $1,105.91, and installment loan 1 is paid in full at the end of year 21.

In year 22 the total monthly payment of installment loans 2-4 is $828.22, and installment loan 2 is paid in full at the end of year 22. In year 23 the total monthly payment of installment loans 3 and 4 is 576.03, and installment loan 3 is paid in full at the end of year 23. In year 24 the total monthly payment of installment loan 4 is $298.34, and installment loan 4 is paid in full at the end of year 24. All debts are now paid in full. The total amount borrowed was $133,500 (or $139,063 if the origination fee is included).

Those of skill in the art will appreciate that FIG. 1 is but one illustrative example of one borrowing scenario according to a DCFI as described herein. Maximums, lifespans of lines of credit, terms of installment loans, interest rates, etc., may be altered depending on the capabilities of the lender and/or borrower, e.g., by having differing tiers of credit with different DCFI terms, etc. For example, the applicant may apply for the cost of attendance for one year at an institution where he or she is enrolled, and then the system may calculate the lifespan maximum based on the annual requested amount, an estimated cost of attendance, or the credit worthiness of the applicant. The cost of attendance may be estimated by the electronic system using a database of school costs after the applicant chooses a school from a list. The estimated amount may become the initial amount or some other initial amount may be used.

One or more aspects of the invention may be embodied in computer-executable instructions, such as in one or more program modules, executed by one or more computers or other devices. Generally, program modules may include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, electronic transmission, carrier signal wave, network storage, etc. As will be appreciated by one of skill in the art, the functionality of the program modules may be combined or distributed (locally or across a network) as desired in various embodiments. In addition, the functionality may be embodied in whole or in part in firmware or hardware equivalents such as integrated circuits, field programmable gate arrays (FPGA), and the like.

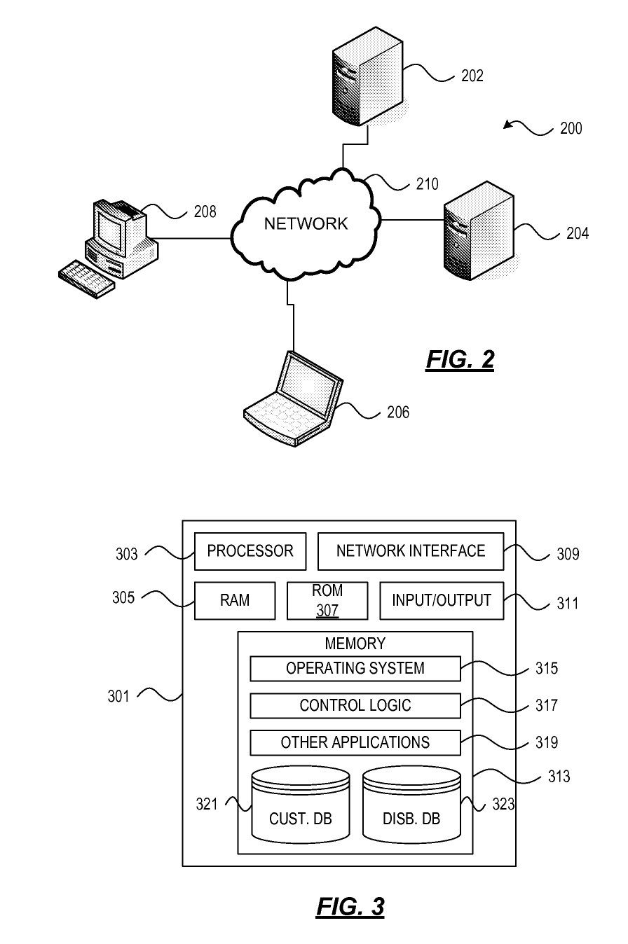

For example, FIG. 2 illustrates a block diagram of a basic computer network architecture which may be used to practice one or more aspects of the invention. In system 200, computers 202, 204, 206, and 208 communicate via a network 210, e.g., the Internet. Each computer 202-208 may be a personal computer, laptop computer, network server, or any other data processing device configured or adapted to perform as described herein. Each computer 202-208 may reside with a borrower, a lender, or a financial facilitator. As described herein, a financial facilitator is any person or entity, other than the borrower or lender, that takes part in, provides information to, or otherwise facilitates the inventive processes and systems described herein (e.g., a charge card provider, merchant, etc.). While the borrower and lender are also financial facilitators, each of the borrower and lender is referred to as such herein.

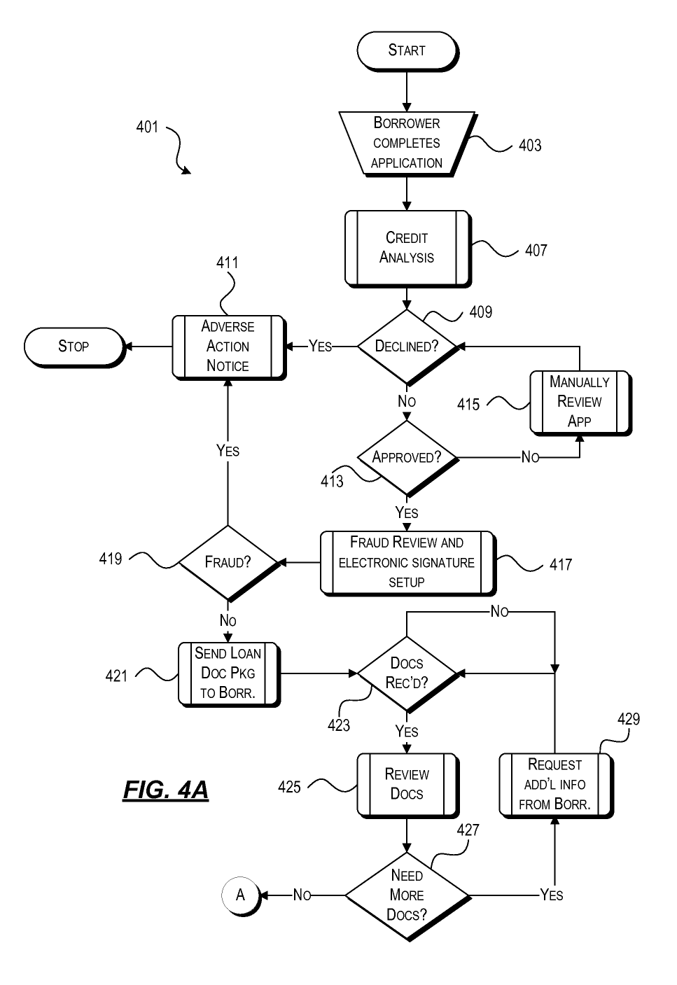

FIG. 3 illustrates a block diagram of a data processing device 301, e.g., a computer server, configured to perform one or more aspects of the invention. Data processing device 301 may include a processor 303, RAM 305, ROM 307, network interface 309, input/output interfaces 311, and memory 313. Memory 313 may further store operating system software 315 for controlling overall operation of the data processing device 301, control logic 317 for controlling overall operation of one or more aspects of the present invention, and other application software 319 providing secondary, support or other functionality which may or may not be used in conjunction with aspects of the present invention. The control logic may be referred to herein as the dual component financial instrument management software 317, or DCFI manager 317. Functionality of the DCFI manager may refer to operations or decisions made automatically based on rules coded into the control logic, or made manually by a user providing input into the system

Memory 313 may also store data used in performance of one or more aspects of the invention, including a customer database 321 and a disbursement database 323. Customer database 321 may include all data pertaining to individual borrowers, including pertinent name and contact information, credit history, revolving loan information, loan information, and associated data. Disbursement database may store information regarding each transaction performed by a borrower against a revolving loan, as well as loan information when a revolving loan is rolled into a fixed term loan as further described below. In some embodiments the customer database may include the disbursement database. That is, the information can be stored in a single database, or separated into different databases, depending on system design.

Those of skill in the art will appreciate that the functionality of data processing device 301 as described herein may be spread across multiple data processing devices, for example, to distribute processing load across multiple computers, to segregate transactions based on geographic location, lender, borrower, or on the educational institution in which the borrower is enrolled, etc. FIGS. 2 and 3 are illustrative only, and not meant to limit the computers or computer architectures which can be used to practice aspects of the invention.

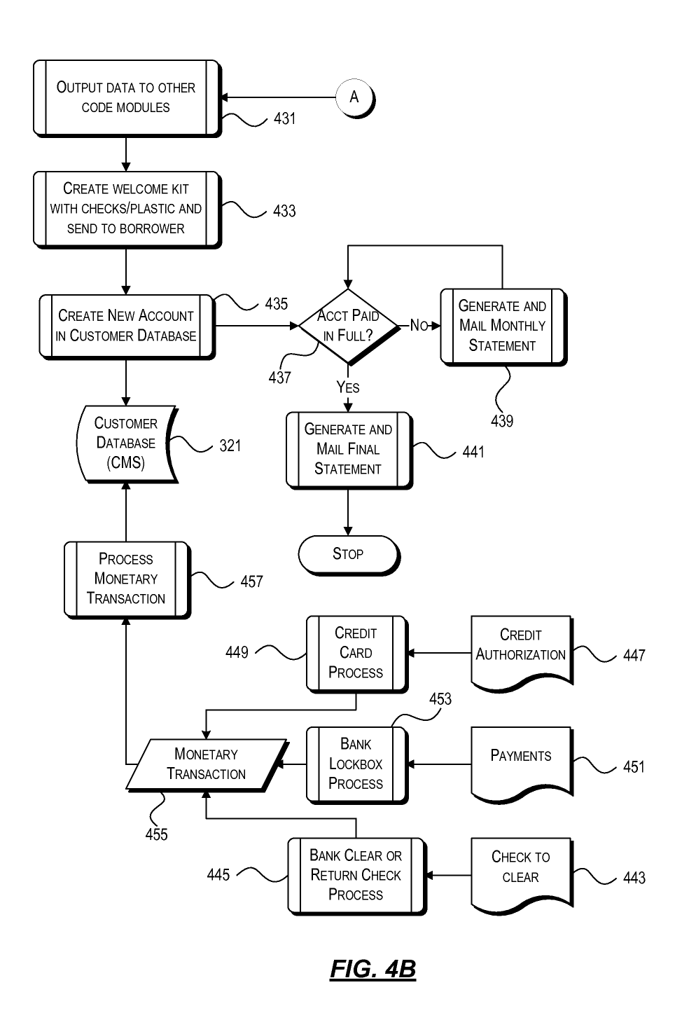

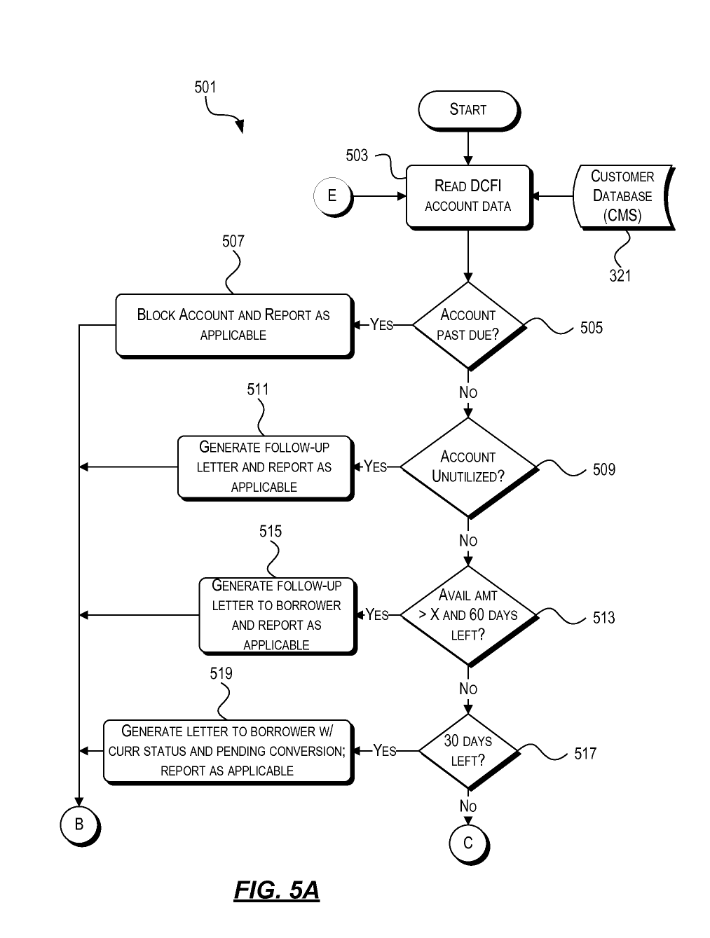

FIG. 4A and FIG. 4B, collectively referred to as FIG. 4, illustrate a flow chart for a method 401 of administering the dual component financial instrument (DCFI) described herein. Initially, in step 403, the then prospective borrower, or applicant, completes a DCFI application. In some embodiments the prospective borrower may enter information using electronic forms on a web page established for this purpose, the prospective borrower may verbally provide the information to an agent of the lender via telephone (e.g., through a sales center) who then enters the information into a computer system on behalf of the prospective borrower, or the prospective borrower may complete a paper application and mail it to the lender. Other application processes may also be used, as are now known in the art or later developed.

Next, in step 407, the lender performs a credit analysis of the prospective borrower to determine whether the borrower meets the DCFI requirements established by the borrower. The credit analysis may include, e.g., analyzing credit reports from any credit reporting agency or company, and/or performing an analysis using an automated system such as LoanCenter® software provided APPRO Systems, Inc., of Baton Rouge, La. The credit software, such as LoanCenter®, may optionally control overall operation of method 401 through step 431, below. The specific software or credit analysis method used is unimportant as long as it provides a measure of credit-worthiness of the prospective borrower. The system may thus use any acceptable formula to calculate the applicant's capacity to repay the loans based on the stated income information. Step 407 or another step may be used to determine the maximum amount the applicant can borrow, e.g., based on the cost of attendance to an education institution, or based on the credit-worthiness of the applicant. Proof of enrollment may be required at establishment of the DCFI as well as on an annual basis if approved.

In step 409 the DCFI manager makes a determination of whether the prospective borrower is declined outright. If so, in step 411 the DCFI outputs an adverse action notice to send to the prospective borrower, e.g., via mail, electronic mail, text message, or other form of communication now known or later developed. In step 413 the DCFI manager determines whether the prospective borrower was approved outright. If not (i.e., the prospective borrower was initially tagged with an ‘undetermined’ or similar status), the prospective borrower's application is manually reviewed in step 415 by an employee of the lender, who makes the final determination him or herself, or inputs additional information into the DCFI manager on which a determination can be made, and method 401 returns to step 409.

If the prospective borrower is approved in step 413, then a fraud review is performed in step 417, which verifies that the applicant is the person represented by the information provided. If the identity of the prospective borrower is verified then a secret key may be generated for use by the borrower to authorize future transactions in lieu of a physical signature. Step 419 determines whether there application contains any information or data that indicates or implies that the prospective borrower may be attempting to defraud the lender and, if so, the method 401 returns to step 411 to send an adverse action letter to the prospective borrower (and optionally notify appropriate authorities). If in step 419 no fraud is detected, then in step 421 the lender sends a loan document package to the prospective borrower. The loan document package may include physical documents mailed or couriered to the prospective borrower, or may include electronic copies of documents electronically sent to the prospective borrower. The loan document package includes all disclosure documents necessary for the borrower to assent to the DCFI as described herein, without requiring additional documents to be signed by the borrower each time the revolving loan is rolled over into an installment loan. Depending on regulations of various states, the borrower may still be required to receive and/or sign minimal documents each time an installment loan is created, such as a Truth-In-Lending disclosure form. In step 423 the lender and/or DCFI manager waits for receipt of the executed documents from the prospective borrower.

The received executed documents are reviewed by the lender and/or DCFI manager in step 425 to verify that no changes were made, all parties have signed the necessary documents, and documentation verifying stated income and proof of enrollment are attached, and a determination is made in step 427 if more documentation is needed. If any of the required documentation is missing or incomplete then an additional request is sent to the prospective borrower in step 429, and the DCFI manager returns to step 423 to wait for receipt of the additional documents. If no more documents are needed, the prospective borrower is now considered an approved borrower, and in step 431 the DCFI manager (or software such as LoanCenter®) provides loan data for use by other systems or program modules, as necessary. For example, in FIG. 3 the DCFI manager 317 or other application software 319 may include or utilize VisionPlus® software from Fiserv Credit Processing Services (Fiserv CPS) of Lake Mary, Fla., to perform the account management functions after an account has been approved by the LoanCenter® software provided by APPRO Systems. The loan data may include an anniversary date, an annual maximum amount of the revolving loan, a lifetime maximum amount of the revolving loan, a credit level on which interest rates may be based, and other information pertinent to the revolving loan and/or installment loans.

With reference to FIG. 4B, in steps 433 and 435 the DCFI manager opens a new DCFI account for the borrower in the Customer Database 321, and assigns an account ID to the newly created account. As part of the new account process, DCFI manager creates or initiates for creation a new account package to send to the borrower. The new account package may include information regarding the terms of the account, how to use the revolving loan, checks with the account ID that the borrower can use to draw against the account, and/or a credit card (e.g., Visa® or MasterCard®) corresponding to the account ID that the borrower can use to draw against the account. Debit cards and/or stored value cards may also be used, e.g., where a co-signor must approve the student's obtaining more money from the revolving loan (i.e., the co-signor approves some amount of funds, which is credited to the debit account or stored value card for use by the cardholder). Once the account has been created, the borrower can draw against the account based on the terms of the account, and the primary new account process is over. Credit cards, debit cards, and stored value cards are collectively referred to herein as charge cards.

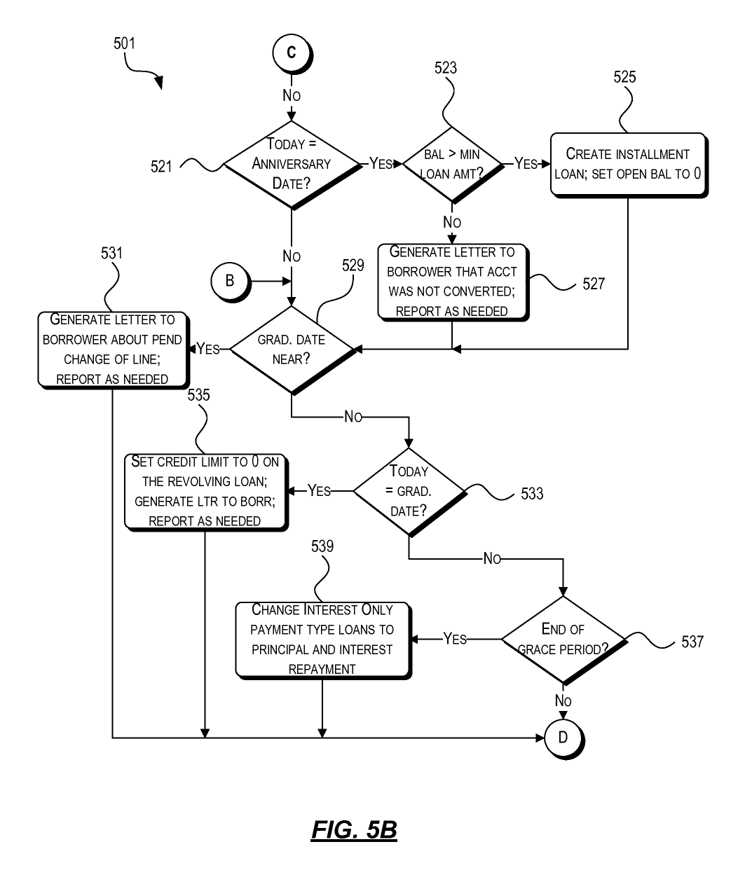

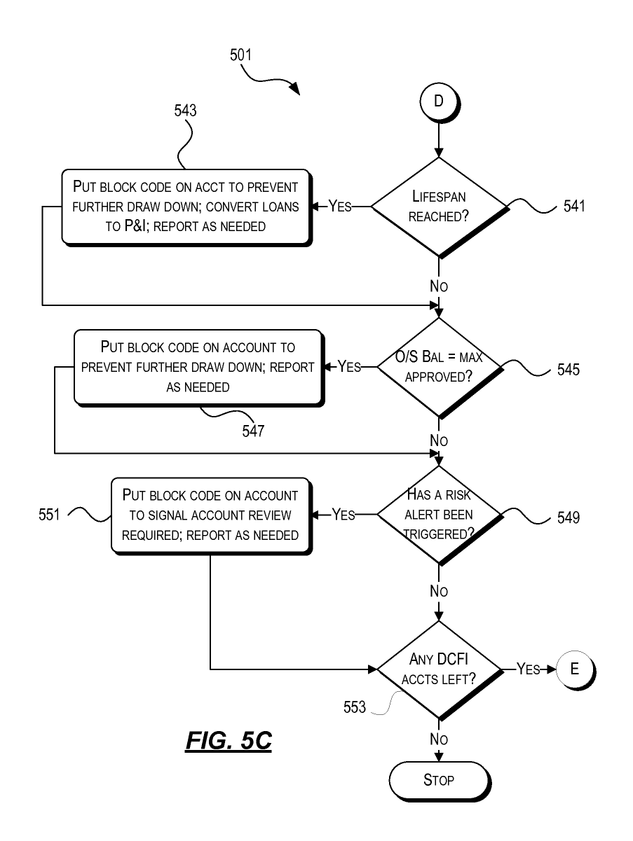

In steps 437-441 the DCFI manager monitors the account status and sends monthly statements to the borrower based on the outstanding balances of the revolving loan and any installment loans created during the DCFI processes, e.g., as described in FIG. 5. In step 437 the DCFI manager determines whether the borrower's account has been paid in full. If so, then the DCFI manager in step 441 generates a communication to send to the borrower including a final statement of account indicating the account is paid in full. If the account is not paid in full, in step 439 the DCFI manager generates a communication to send to the borrower including a monthly statement of account and amount due.

Steps 447 through 457 illustrate a process as a monetary transaction is processed against the borrower's DCFI account. In step 447 the borrower attempts to use the charge card corresponding to the account to make a purchase at a merchant, either in a store, online, over the phone, or any other transaction in which a charge card can be used. In step 449 the charge card company and/or the lender and/or the DCFI manager make a determination of whether to authorize the charge card transaction. The authorization can be based on various factors, including whether the borrower has enough credit left to cover the transaction, and whether the transaction is at an approved merchant. Merchants may be approved based on the services they offer, based on their proximity to the educational institution in which the borrower is enrolled, based on whether a co-signor of the borrower (e.g., a parent) has approved the merchant, or other criteria defined in the DCFI manager. If the transaction is approved, the details 445 of the transaction are sent to the DCFI manager and processed in step 457. The customer database 321 is altered accordingly.

In step 443 the borrower writes a check against the revolving loan, and in step 445 the bank on which the check is drawn processes the check. If the check clears, the details 455 of the transaction are sent to the DCFI manager and processed in step 457. The customer database 321 is altered accordingly.

In step 451 the borrower makes a payment against his or her account, and in step 453 the payment is processed by the bank lockbox process. Bank lockbox processes are generally known in the art, and include a financial institution (such as a bank) processing payments received from borrowers, depositing the received payments into an account of the lender, and providing the lender a detailed breakdown of the received payments, e.g., via an electronic file for importing into the lender's database. Thus, in step 457, the details 455 of the payment are sent to the DCFI manager and processed in accordance with the account terms. The customer database 321 is altered accordingly.

FIG. 5A, FIG. 5B, and FIG. 5C collectively referred to as FIG. 5, illustrate an administrative method 501 automatically performed each day by the DCFI manager to determine the status of each account and whether to take any administrative actions, including generating letters, blocking account access, creating a new installment loan to pay off a revolving loan, etc. In step 503, using data from customer database 321, DCFI manager reads account data for a DCFI account. In steps 505 and 507 DCFI manager determines if the account is past due by some predefined number of days, e.g., thirty days, and if so, puts a block on the account to prevent further draws against the account, and reports the account to appropriate code modules or personnel to inform the borrower, begin collections, etc.

In steps 509 and 511 the DCFI manager determines whether the account is unutilized, i.e., the borrower has had the account open a certain amount of time, e.g., thirty days, and has not drawn from the account. If the account is unutilized, the DCFI manager generates a follow up letter to send to the borrower and reports the account to appropriate personnel, e.g., customer service, to make a courtesy call to the borrower to remind the borrower that the account is active. Using steps 509 and 511 the lender can remind the borrower that the account is available, thereby encouraging the borrower to draw against the account.

In steps 513 and 515 the DCFI manager determines whether the revolving loan account is nearing its termination or anniversary date, and if there is remaining credit available above a predefined amount, e.g., at least 5% of the annual maximum. If so, the DCFI manager generates a letter to the borrower informing him or her of such, and reports the account to appropriate personnel, e.g., customer service, to make a courtesy call to the borrower to remind the borrower that he or she has unused credit left. Steps 513 and 515 serve to encourage a borrower to maximize the utilization of the DCFI account.

In steps 517 and 519 the DCFI manager determines whether the account is nearing its anniversary or termination date and, if so, generates a letter to the borrower with the current account status and explaining the installment loan conversion process to pay off the balance of the revolving loan. Steps 517 and 519 are primarily informative and keep the borrower abreast of procedures and what to expect as the conversion takes place.

In steps 521 through 527 the DCFI manager determines whether or not to open a new installment loan. In step 521, the DCFI manager determines whether the current day is the anniversary date of the DCFI account (other criteria may alternatively be used). If not, method 501 jumps to step 529. If the current date is the anniversary date of the DCFI account, then in step 523 the DCFI manager determines whether the current balance of the revolving loan is greater than a predetermined minimum allowable loan amount for an installment loan. This minimum amount may optionally be established so that installment loans are only created when it is financially worthwhile to do so. In one embodiment, this minimum allowable loan amount may be $3,000. If the revolving loan balance is greater than the minimum allowable loan amount, then in step 525 the DCFI manager creates a new installment loan for that borrower. The new installment loan has a principal amount equal to the revolving loan balance plus any origination fees and/or costs. The revolving loan balance is reset to zero, and the DCFI manager outputs data as applicable, e.g., to customer service for reporting to the borrower. As part of step 525 the DCFI manager may also generate and send to the borrower a truth-in-lending disclosure form as required by Regulation Z (12 C.F.R. §226 et seq.).

If in step 523 the revolving loan balance is below the minimum allowable loan amount, then in step 527 the DCFI manager generates a letter to the borrower informing him or her than the outstanding balance on the revolving loan was too low to be paid off by an installment loan, and therefore the balance will remain on the revolving loan under the existing terms of the revolving loan. The DCFI manager may also report such information to customer service or others as applicable.

In embodiments where the DCFI is education-related, in addition to the anniversary date of the creation of the revolving loan the product terms may also consider the student graduation date. Thus, in step 529 the DCFI manager determines whether the borrower is nearing graduation and, if so, in step 531 generates an information letter to the borrower confirming the graduation date and informing the borrower about the forthcoming changes to the account, e.g., termination of revolving loan, creation of one more installment loan repayment to include principal and interest, etc. Method 501 then proceeds to step 541.

In step 533, DCFI manager determines whether the current day is the graduation date of the borrower. If so, DCFI manager in step 535 sets the credit limit to zero (0) on the revolving loan to prevent further draws until the next anniversary date (or optionally immediately establishes an installment loan to pay off the revolving loan), and prepares a letter to the borrower informing the borrower of the change in account status.

In step 537 the DCFI manager determines whether the current date is some predetermined amount of days after graduation corresponding to a grace period in which the borrower can continue making interest only payments. In some embodiments the grace period may be zero days; in other embodiments, the grace period may be 60 days, 6 months, or some other amount established by the lender. If the current day is the end of the grace period, then in step 539 the DCFI manager changes the repayment terms as applicable, e.g., to include principal and interest, and generates a letter to the borrower informing the borrower of the change in repayment terms.

In steps 541 through 551 the DCFI manager performs miscellaneous administrative tasks. In step 541 the DCFI manager determines whether the DCFI account has been open for the specified lifespan of the DCFI account, e.g., 4 years, 10 semesters, 84 months, etc. If so, then in step 543 the DCFI manager puts a block on the account to prevent further draws; establishes a last installment loan to pay off the balance of the revolving loan, and optionally immediately converts all loans to principal and interest payments. The DCFI manager may output data or reports to appropriate code modules and/or personnel as applicable.

In step 545 the DCFI manager determines whether the outstanding balance on the revolving loan meets the maximum approved amount (annual and/or lifetime). If so, then in step 547 the DCFI manager puts a block on the revolving loan to prevent further draws. Draws are prevented permanently if the lifetime maximum has been reached, and temporarily until the revolving loan is paid off if only the annual maximum has been reached.

In step 549 the DCFI manager determines whether any risk alerts have been triggered with respect to the account, e.g., based on the borrower's actions, based on an odd transaction drawing from the revolving loan, based on an ongoing monitored credit-worthiness of the borrower, etc. If a risk alert is triggered, then in step 551 the DCFI manager puts a block on the revolving loan to prevent further draws and notifies appropriate personnel and/or code modules for follow up investigation. In step 553 the DCFI manager determines whether any DCFI accounts remain to be analyzed for the current day. If so, the method 501 returns to step 503 to analyze the next DCFI account.

Those of skill in the art will appreciate that the above method is illustrative in nature, and that certain steps may be optional, steps may be added, and the order to the recited steps need not necessarily be followed. Using the above descriptions, one of skill in the art will be able to modify or customize parts of a computer assisted loan servicing system to provide a dual component financial instrument as described herein.

The above-described DCFI allows a student to apply for funds for an entire secondary education using only a single application process, or at a minimum a less intricate application process than previously offered, while concurrently allowing a lender to move quickly and efficiently securitize student loans. A single account may be used to track multiple loans, including the revolving loan and one or more installment loans. The revolving loan remains open until the student graduates or up to a predefined amount of time, and is annually paid off by a new installment loan automatically created on the borrower's behalf. Those of skill in the art will appreciate that other events may trigger the creation of an installment loan, such as the balance of the revolving loan being a certain amount, the request of the borrower, etc. The borrower thus might receive only a single monthly statement, thereby simplifying the communications the borrower receives from financial institutions. In families having multiple students having DCFI loans, while each student has a separate account, the monthly statements may be combined to simplify accounting for a co-signor or guarantor of all loans, e.g., a common parent of all students.

While each installment loan is preferably created automatically without human intervention, those of skill in the art will appreciate than an automatic process may still require limited human input and/or oversight. A lending manager may optionally each day review and approve the installment loans that are to be created, or at least review prospective installment loans for accounts with suspicious activity, suspect credit-worthiness, etc. Other processes or components of methods described herein, such as preparation of letters to borrowers, may also be fully or partially automated to expedite processing time.

Various modifications may be made during the life of the DCFI, including altering the interest rates and/or maximum amounts based on economic factors such as income, cost of attendance, prime interest rate, and the like. Payments may also be adjusted to accommodate the needs and capabilities of the parties to the transaction, such as allowing deferred payments while in school, interest only while in school, or some other arrangement agreed between the lender and the borrower. The terms on the installment loans may vary, e.g., from 10 to 30 years, also optionally varying the interest rates.

The introduction and adoption of electronic signatures simplifies the disclosure and truth in lending process and encourages the use of electronic document presentation. Variations may be offered based on credit worthiness of an application by establishing credit tiers (e.g., 5 tiers of credit levels) having different associated interest rates and maximums. Delinquency status and fees may also be based on the credit tier to which the borrower belongs.

Using the above-described dual component financial instrument, individual installment loans can be made available for securitization in a more simplified manner than previously possible, because a student is not required to reapply for a loan each year. Appropriate legal disclosures, contracts, and other documents (e.g., promissory notes) are presented to the student at the time the DCFI account has been approved, and the student agrees to all terms at the establishment of the account, or at least all terms which can be agreed to ahead of time (creation of each installment loan may still require minimal disclosures and/or agreements).

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

What is claimed is:

1. A computer-assisted method for administering a financial instrument having a revolving loan component and a second loan component, said method comprising:
(i) storing in computer memory, revolving loan information corresponding to a revolving loan provided to a borrower by a lender;
(ii) on an anniversary date of the revolving loan, the computer automatically establishing on behalf of the borrower a second loan for a predetermined amount, and storing in computer memory loan information corresponding to the second loan, wherein the second loan comprises a fixed-term installment loan; and
(iii) the computer automatically updating the revolving loan information in the computer memory by crediting the predetermined amount towards an outstanding balance of the revolving loan.

2. The computer-assisted method of claim 1, further comprising repeating steps (ii) and (iii) on each anniversary date, and wherein step (ii) comprises automatically establishing a new loan on each anniversary date.

3. The computer-assisted method of claim 2, wherein steps (ii) and (iii) are repeated up to a predetermined number of years during which the borrower is enrolled in an educational institution.

4. The computer-assisted method of claim 1, wherein steps (ii) and (iii) are repeated while a cumulative total balance of all loans to the borrower plus the then current outstanding balance of the revolving loan are below a predetermined maximum amount.

5. The computer-assisted method of claim 1, wherein the predetermined is equal to the outstanding balance of the revolving loan.

6. The computer-assisted method of claim 1, further comprising providing a charge card usable by the borrower to draw funds from the revolving loan.

7. The computer-assisted method of claim 6, further comprising restricting merchants at which the charge card can be used.

8. The computer-assisted method of claim 7, wherein the restricted merchants are based on an educational institution in which the borrower is enrolled.

9. The computer-assisted method of claim 7, wherein use of the charge card is restricted to merchants within a predetermined geographical area in relation to the educational institution.

10. A computer system, comprising:
a processor; and
a memory storing computer executable instructions which, when executed by the processor, perform a method for administering a financial instrument having a revolving loan component and a second loan component, said method comprising:
(i) storing revolving loan information corresponding to a revolving loan provided to a borrower by a lender, wherein the revolving loan information comprises a maximum annual balance and a maximum lifetime balance; and
(ii) on or near each anniversary date of an establishment date of the revolving loan, rolling over the revolving loan by:
(a) storing loan information for a discrete fixed-term installment loan automatically established on behalf of the borrower for an amount of money based on a current outstanding balance of the revolving loan;
(b) automatically crediting the amount of money towards the current outstanding balance of the revolving loan; and
(c) automatically adding the predetermined amount to a lifetime balance of the revolving loan,
wherein the outstanding balance of the revolving loan is not allowed to exceed the maximum annual balance, and
wherein the lifetime balance plus the current outstanding balance of the revolving loan is not allowed to exceed the maximum lifetime balance.

11. A charge card comprising a memory storing account information corresponding to a financial instrument having a revolving loan component and a second loan component, wherein use of the charge card draws from the revolving loan component of the financial instrument, and wherein the revolving loan is automatically paid off by a new automatically created fixed-term installment loan on or near each annual anniversary of an establishment date of the financial instrument.

12. The charge card of claim 11, restricted to use at certain merchants.

13. The charge card of claim 11, restricted to use at certain merchants based on an educational institution in which a cardholder of the charge card is enrolled.

14. The charge card of claim 13, restricted to use at certain merchants based on a geographic area associated with an educational institution in which a cardholder of the charge card is enrolled.

15. A method of processing a charge card transaction for a financial instrument having a revolving loan component and a second loan component, wherein use of the charge card draws from the revolving loan component of the financial instrument, and wherein the revolving loan is automatically paid off by a new automatically created fixed-term installment loan on or near each anniversary of an establishment date of the financial instrument, comprising:
(i) receiving at a data processing device via a data network a charge card authorization request, sent by a merchant, comprising a requested amount and an account identifier, wherein the account identifier corresponds to the financial instrument;
(ii) the data processing device determining whether the requested amount is within an annual credit limit of the revolving loan component;
(iii) the data processing device determining whether the requested amount is within a lifetime limit of the revolving loan component;
(iv) the data processing device approving the charge card authorization request when the requested amount is within the annual credit limit of the revolving loan component and the requested amount is within the lifetime limit of the revolving loan component, and denying the charge card authorization request when the requested amount would exceed the annual credit limit of the revolving loan component or the requested amount would exceed the lifetime limit of the revolving loan component;
(v) the data processing device sending via the data network for delivery to the merchant a charge card authorization response comprising the result of step (iv).

16. The method of claim 15, wherein step (iv) further comprises denying the charge card authorization request when the merchant is not an allowed merchant, regardless of whether the requested amount is within the annual credit limit of the revolving loan component and the requested amount is within the lifetime limit of the revolving loan component.

17. The method of claim 16, wherein a set of allowed merchants is based on an educational institution in which a cardholder of the charge card is enrolled.

18. The method of claim 16, wherein a set of allowed merchants is based on a geographic area associated with an educational institution in which a cardholder of the charge card is enrolled.

19. One or more computer readable storage media storing computer executable instructions that, when executed, cause a computer to perform a method comprising:
storing in a database a maximum annual balance and a maximum lifetime balance corresponding to a borrower;
opening on behalf of the borrower a revolving line of credit having the maximum annual balance;
for a predetermined number of years while the borrower is enrolled in an educational institution, on a date based on an annual anniversary of opening the revolving line of credit, establishing a new fixed-term installment loan and to pay off a then current balance of the revolving line of credit; and
when the maximum lifetime balance minus the total balance of all established fixed-term installment loans is less than the maximum annual balance, denying any requests by the borrower to charge against the revolving line of credit where the requested charge amount is greater than the maximum lifetime balance minus the total balance of all established fixed-term installment loans minus any outstanding balance of the revolving line of credit.

20. The computer readable media of claim 19, wherein the method further comprises associating a charge card with the revolving line of credit, and debiting the revolving line of credit based on the borrower's use of the charge card.
